(19) United States
(12) Patent Application Publication
(10) Pub. No.: US 2020/0071000 A1
(43) Pub. Date: Mar. 5, 2020

(54) INTERIOR LIGHTING, A TRIM ELEMENT, AN AIRCRAFT WITH INTERIOR LIGHTING AND A METHOD FOR THE PRODUCTION OF INTERIOR LIGHTING

(71) Applicant: Airbus Operations GmbH, Hamburg (DE)

(72) Inventor: Carsten KOHLMEIER-BECKMANN, Hamburg (DE)

(21) Appl. No.: 16/553,707

(22) Filed: Aug. 28, 2019

(30) Foreign Application Priority Data
Aug. 30, 2018 (DE) 10 2018 121 194.5

(51) Int. Cl. B64D 47/02; B64C 1/06; F21V 3/06

(52) U.S. Cl. CPC B64D 47/02; B32B 3/12; F21V 3/0625; B64C 1/066

(57) ABSTRACT

Interior lighting for an aircraft with a light source, a trim component, which has a recess, and a covering, which conceals the recess. The light source is arranged in the recess and emits light in a predetermined operating mode. The covering has the optical characteristics of an outer coating or a material of the trim component, wherein the light source is invisible from any position in the interior of the aircraft when viewing the trim component in the normal operating mode. The trim has a recess, a light source and a covering. Also, an aircraft with interior lighting and a method for the production of interior lighting.

### CROSS-REFERENCES TO RELATED APPLICATIONS

This application claims priority from German Patent Application No. 10 2018 121 194.5 filed Aug. 30, 2018, the entirety of which is incorporated herein by reference.

### FIELD OF THE INVENTION

The invention concerns interior lighting, a trim element, an aircraft with interior lighting, and a method for the production of interior lighting. In particular, the invention concerns interior lighting with a light source in a recess of a trim component of the aircraft, and a covering such that in a normal operating mode of the aircraft the light source is invisible from any position in the interior of the aircraft when viewing the trim component. Furthermore, the invention concerns a trim element with lighting, an aircraft with such interior lighting, and a method for the production of such interior lighting.

### BACKGROUND OF THE INVENTION

Usually aircraft lighting and emergency lighting equipment is provided on or in ceiling panels, but it can also be arranged on or in joints between trim elements of the aircraft. The arrangement in joints between trim elements serves to simplify the installation, as the lighting can be mounted before the trim elements are fixed. In addition, the trim element does not need to be modified, as is the case when the lighting is mounted on such a trim element. However, if one of the trim elements is incorrectly aligned, or the trim element is later moved, the lighting can be concealed.

The invention is based on an object of providing interior lighting that provides reliable lighting, and at the same time is arranged as inconspicuously as possible in an aircraft.

### SUMMARY OF THE INVENTION

This object may be achieved by interior lighting with the features of one or more embodiments described herein, by a trim element with the features of one or more embodiments described herein, by an aircraft with the features of one or more embodiments described herein, and by a method with the features of one or more embodiments described herein.

According to a first aspect, interior lighting for an aircraft comprises a light source that is equipped so as to emit light into an interior of the aircraft, if the aircraft departs from a normal operating mode, and a trim component with a recess that is equipped so as to accommodate the light source. Furthermore, the interior lighting can comprise a covering, which conceals the recess and has the optical characteristics of an external coating or a material of the trim component. This enables the light source to be invisible from any position in the interior of the aircraft when viewing the trim component in the normal operating mode.

For example, the normal operating mode can relate to a mode of the aircraft in which the general interior lighting is switched on. An aircraft mode other than the normal operating mode can, for example, comprise an emergency operating mode. Thus, the light source can be equipped so as to emit light into the interior of the aircraft if the aircraft enters the emergency operating mode.

Similarly, a particular state of the aircraft and/or a component of the aircraft can determine a mode deviating from the normal operating mode. For example, this can be the phase during boarding or disembarkation, and/or a phase in which an on-board toilet is occupied.

With this arrangement of the light source in a recess of a trim component, it is always ensured that the light emitted by the light source adequately illuminates the interior of the aircraft. In addition, the concealment of the light source by the covering ensures that people do not perceive the interior lighting (in particular the emergency lighting) in the normal operating mode of the aircraft. This has the advantage that people who develop fears or other psychological stress as a result of the presence of visible emergency lighting do not have to experience such adverse effects.

The trim component can be cladding for a primary structure of the aircraft. For example, it can take the form of a wall panel or a ceiling panel. The trim component can also clad or form part of a monument or another secondary component. Thus the trim component can, at least partially, form a monument wall or a monument ceiling, or can be arranged on the latter. For example, the trim component can be a ceiling element of a toilet or a kitchen, or can be attached to, or can form, the front or bottom side of overhead lockers above the passenger seats.

In one design variant, the light source is arranged on one side of the recess that faces away from the interior of the aircraft. The light source can likewise also occupy the entire recess and can, for example, be held in the recess in a force fit by means of a clamping action. The light source can take the form of a light emitting diode (LED or OLED), or another efficient light source.

In another design variant of the interior lighting, the trim component is curved. Since most areas of an aircraft have curves, a curved trim component is particularly easy to fit into standard aircraft.

In an alternative or additional development, the recess is arranged on a side of the trim component facing the interior, and the covering conceals the recess on the side of the trim component facing the interior. In other words, the recess is provided on a side of the trim component, which later represents the visible side of the trim component. Here the recess may only take up part of the trim component in the direction of the layer thickness of the trim component. Alternatively, the recess may also extend through the entire layer thickness of the trim component.

In yet another design variant of the interior lighting, the covering forms a continuous surface with a surface of the trim component facing the interior. In other words, on the surface of the trim component facing the interior of the aircraft, there are no projections or depressions present and/or detectable at a transition between the surface of the trim component and the covering.

Here the trim component and the covering can be formed in one piece. When forming the one-piece trim component/covering combination, a continuous shape can be used here that forms both the surface of the area of the covering and also the surrounding area of the trim component. Alternatively, the covering can also be produced separately from the trim component, and in particular separately from the material forming the surface of the trim component, and can then be inserted into the recess. For example, the covering can have a certain layer thickness, or sections that extend essentially at right angles away from the actual covering, such that the covering body can be inserted into the recess and held there in a force fit, or adhesively bonded therein. Here any joint between the covering and the trim surface must be filled with an appropriate sealing material so as to prevent the transition from becoming visible.

In a further design variant, the trim component is formed as a honeycomb structure. For example, the trim component can be formed from a honeycomb structure on which a foil, a laminate, or another planar component is positioned on at least one side, which forms the visible side of the trim component. Such a structure corresponds to half a sandwich panel. Needless to say, the trim component can also be a complete sandwich panel, which is provided on both sides of a body with a foil, a laminate, or another planar component. By the use of a foil, a laminate, or another planar component, the covering and the material forming the surface of the trim component can be produced in one piece in a very simple and cost-effective manner In addition, the material forming the surface of the sandwich panel is usually difficult to penetrate, so that no additional protection of the recess and the light source inserted therein is necessary.

In a further development, the recess can be formed in a single cell of the honeycomb structure. In other words, a honeycomb cell forms the recess. This prevents a weakening of the material of the trim component. Here the cross-section of a honeycomb cell can be hexagonal (when looking at a plan view of the trim component). Needless to say, the cross-section of the honeycomb cell can also be square, another rectangular shape, or another polygon. Alternatively, the recess can likewise also be produced from the area of a plurality of (adjacent) honeycomb cells, by removing the material forming the honeycomb cells.

Alternatively, the trim element can be produced from a solid material. For example, it can be produced from a foamed plastic material. Here the recess should if at all possible be produced from the rear side (the side facing away from the interior), so as to retain the covering above the recess. Needless to say, the recess can also be produced through the entire trim component, and the covering can then be positioned in/on the latter.

In yet another design variant of the interior lighting, the covering is designed as an optical diffuser, which scatters the light emitted by the light source into the interior of the aircraft. The optical diffuser can be produced in terms of a milky material, a roughened material, or similar Alternatively or additionally, the diffuser can also comprise one or more micro lenses. This allows a light distribution to be optimized in the area of the aircraft interior that is illuminated by the lighting.

Alternatively or additionally, the covering can have a semitransparent layer that is permeable to the light emitted by the light source in the direction of the interior of the aircraft. In the opposite direction, however, the semitransparent layer is (for the most part) impermeable. By this means, the light source located in the recess behind the covering is not visible from any position in the interior of the aircraft. In particular, when the light source is switched off, the recess and the light source cannot be detected.

In addition, the covering, for example the semitransparent layer, can be provided with a layer of color that corresponds to a color of an area of the trim component that surrounds the recess. By this means, the recess and the light source it contains can easily be concealed. The covering can alternatively or additionally be designed in such a way that, when the light source is switched on, light is emitted in a color other than that of the area of the trim component surrounding the recess. The light source can also be equipped so as to emit light of a color other than the color of the area surrounding the recess. This enables it to be deployed for further purposes other than emergency lighting. For example, the lighting can be used as night lighting, in which the light source is operated at a lower intensity, and/or with a particular color (red tones) (the night operating mode of the aircraft). Alternatively or additionally, different areas of the aircraft can be identified by different colors. For example, the different booking classes (economy, business, first) can be color-coded, making it easier for passengers to board the aircraft and find the right seats (during an initial aircraft boarding mode).

Alternatively or additionally, a further lighting function (in addition to, or instead of, emergency interior lighting) can also be enabled in terms of a specified color of the light emitted by the interior lighting, and/or in terms of a specified shape of the recess, and/or in terms of a specified shape of the covering. Thus, the lighting in the trim component can assume a certain form, which displays further information to the aircraft passenger. For example, an arrow shape can be displayed that indicates a direction for the boarding or disembarking passengers from the entrance, or to the exit, respectively. The display of pictograms and/or images is also possible by an appropriate selection of color and/or shape, which pictograms and/or images indicate, for example, whether an on-board toilet is occupied or vacant, whether passengers should fasten their seat belts, whether electronic devices must be switched off, etc.

In yet a further design variant, the trim component comprises a flexible printed circuit board to connect to the light source arranged on a side of the trim component facing away from the interior. The light source can be mounted directly on and connected to the flexible printed circuit board, or can be integrated into the latter. The flexible printed circuit board can also have an electrical connection to which a power supply line and/or a control line for the light source can be connected. Likewise, control electronics or other electrical components for operating the light source can be arranged on, or integrated into, the flexible printed circuit board.

In addition to its lower weight compared to rigid printed circuit boards, a flexible printed circuit board can easily be attached to a side of the trim component facing away from the interior, in particular in the case of a curved trim component. For this purpose, the flexible printed circuit board can be attached to the trim component by means of an adhesive layer, double-sided adhesive tape and/or a Velcro fastener.

Alternatively or additionally a printed circuit board can also be integrated into the trim component. Here the printed circuit board is arranged in the trim component in such a way that it can be connected to the light source in or on a recess.

In a design variant, the trim component and/or the recess are/is further equipped so as to accommodate completely a further light source for the normal operating mode, wherein the light source is equipped so as to emit light into the interior of the aircraft in the normal operating mode. In other words, the recess in the trim component is also used for the “normal” lighting of the interior of the aircraft. This enables a very uniform image of the interior of the aircraft, and also reduces the likelihood of people sensitive to emergency lighting being frightened by the switchover to an emergency operating mode.

According to a second aspect, a trim element for an aircraft comprises a light source that is equipped so as to emit light into an interior of the aircraft, if the aircraft departs from a normal operating mode, and a recess that is equipped so as to accommodate the light source. Furthermore, the trim element can comprise a covering that conceals the recess and has the optical characteristics of an outer coating, or a material of the trim element. This enables the light source to be invisible from any position in the interior of the aircraft when viewing the trim element in the normal operating mode.

The trim component can be cladding for a primary structure of the aircraft. For example, it can take the form of a wall panel or a ceiling panel. The trim component can also clad, or form part of, a monument or another secondary component. Thus the trim component can, at least in part, form a monument wall or a monument ceiling, or can be arranged on the latter. For example, the trim component can be a ceiling element of a toilet or a kitchen, or can be attached to, or can form the front or bottom side of overhead lockers above the passenger seats.

According to another aspect, an aircraft comprises at least interior lighting in accordance with the first aspect.

According to yet another aspect, a method for the production of interior lighting for an aircraft comprises the following steps:
Provision of honeycomb material for a trim component;
Provision of a cover plate for the trim component;
Adhesive bonding of the honeycomb material and the cover plate so as to produce the trim component;
Production of a recess at least in the honeycomb material;
Mounting of a light source entirely within the recess, wherein the light source is equipped so as to emit light if the aircraft departs from a normal operating mode; and
Covering of the recess with a covering that has the optical characteristics of an outer coating, or a material of the trim component, wherein the light source is invisible from any position in the interior of the aircraft when viewing the trim component in the normal operating mode.

The order of the steps in the method after the provisioning is irrelevant here and the present disclosure is not limited to the order as specified above.

Furthermore, the production of a recess can coincide with the production of a honeycomb structure for the honeycomb material. In other words, a honeycomb cell can represent a recess in the production of the honeycomb material. Alternatively, during the production of the honeycomb material, a larger cell can be produced at the location intended for the recess, or already formed cells can be removed so as to produce a larger honeycomb cell.

The aspects, further developments, designs and variants described here can be combined in any manner, so that further design variants not explicitly described are comprised in the present disclosure.

### BRIEF DESCRIPTION OF THE DRAWINGS

In what follows, examples of embodiment of the invention are described in more detail with the aid of the figures.

FIG. 1 shows schematically a longitudinal cross-section of interior lighting for an aircraft,

FIGS. 2 to 5 show schematically longitudinal cross-sections of interior lighting design variants for an aircraft,

FIG. 6 shows schematically a view of interior lighting,

FIG. 7 shows schematically an aircraft with interior lighting, and

FIG. 8 shows a flow chart of a method for the production of interior lighting.

### DETAILED DESCRIPTION OF THE PREFERRED EMBODIMENTS

In accordance with the present invention, interior lighting is described for an aircraft with a light source in a recess concealed by a covering. Furthermore, a trim component with interior lighting is described, as is an aircraft with such interior lighting, together with a method for the production of interior lighting.

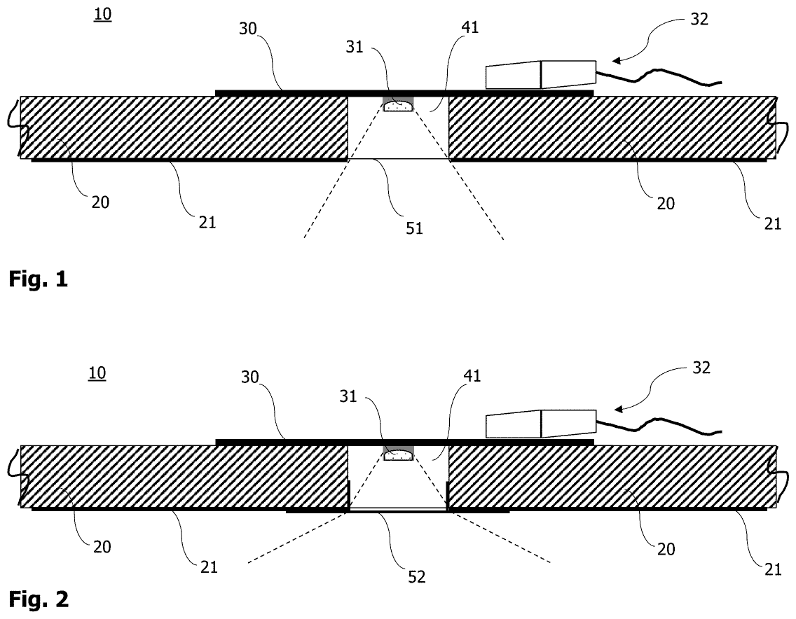

FIG. 1 shows schematically a longitudinal cross-section of interior lighting 10 for an aircraft 100. The interior lighting 10 includes at least a trim component 20, which has a recess 41. In the recess 41 is accommodated a light source 31, which is equipped so as to emit light into an interior 110 of the aircraft 100. In particular, the light source 31 can emit light into the interior 110 if the aircraft 100 departs from a normal operating mode and enters an emergency operating mode, for example. Thus, the interior lighting 10 can take the form of emergency interior lighting.

The interior lighting 10 also has a covering 51, which conceals the recess 41. Here the covering 51 has the optical characteristics of an outer coating 21, or an (external) material of the trim component 20. In FIGS. 1 to 5, the covering 51 is indeed represented by a thinner line than the outer coating 21 of the trim component 20. However, this serves only to distinguish between the coating 21 and the covering 51. The coating 21 and the covering 51 can be produced from the same material, can be produced in one piece, or can be produced in one piece from different materials. Alternatively, the covering 51 can be designed in the form of a film that is adhesively bonded to the coating 21.

A printed circuit board 30, for example a flexible printed circuit board 30, is arranged on a side of the trim component 20 facing away from the interior 110. The printed circuit board 30 has the light source 31, which can, for example, be implemented in the form of an LED, OLED, light bulb, or another light source. In addition, an electrical connection 32 is provided on the printed circuit board, which can be designed, for example, to be similar to an electrical coupling, into which a plug can be plugged so as to connect a connecting cable.

In FIG. 2 the recess 41 is covered by a diffuser 52. Here, too, the diffuser 52 is represented as if it were sitting on the coating 21. However, this only serves for being able to distinguish between the coating 21 and the diffuser 52. Needless to say, the surface of the diffuser 52 and the coating 21 is continuous, that is to say, without elevations or incisions, so that the optical characteristics of the outer coating 21 and the covering designed as a diffuser 52 are ensured. The light scattered by the diffuser 52 enables the interior 110 to be illuminated over a larger area.

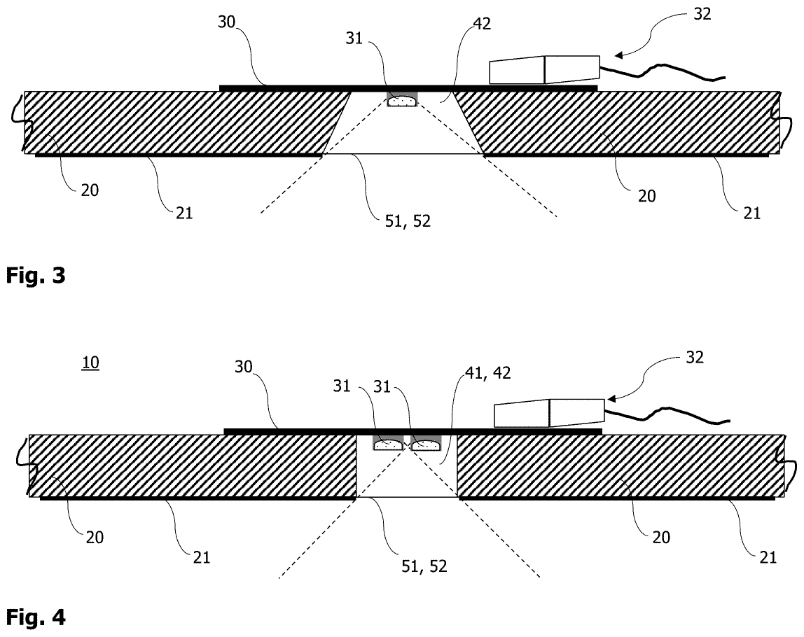

The design variant that is represented in FIG. 3 has a recess 42 that is embodied in a conical or trapezoidal manner This enables a wider light distribution than in the variant represented in FIG. 1.

A further design variant with a plurality of light sources 31 is represented in FIG. 4. On the one hand, the light sources 31 can be used for emergency lighting or for identification, whereby a higher level of brightness can be achieved in the interior 110. Alternatively, one of the light sources can be used for emergency lighting or identification, while another light source, or all other light sources, can be deployed for lighting in the normal operating mode of the aircraft 100.

In the variant in FIG. 4, a recess 41, 42, together with a covering 51, 52, can be deployed in accordance with each of the variants in FIGS. 1 to 3.

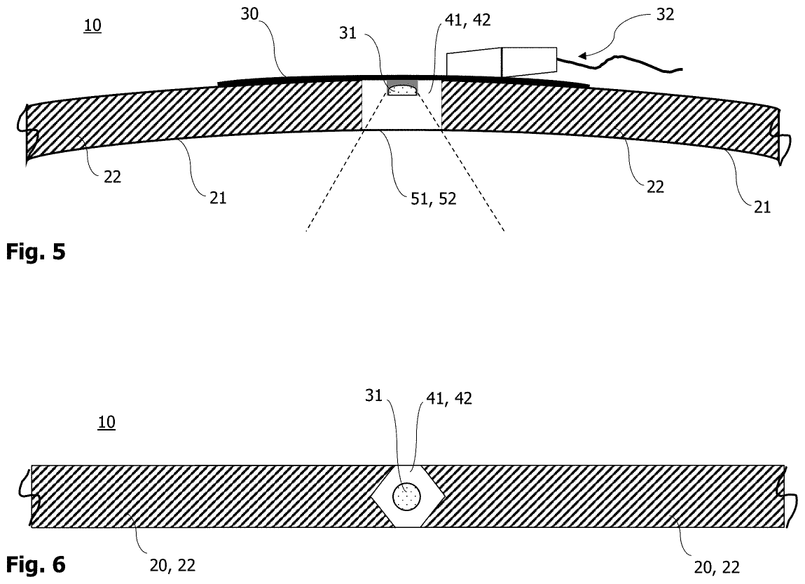

FIG. 5 shows a further variant, wherein the trim component 22 is curved. Here the printed circuit board 30 can be a flexible printed circuit board 30 so that it can be attached to the trim component 22 with as little force as possible. In this variant the recess 41, 42, together with the covering 51, 52, can also be deployed in accordance with each of the variants in FIGS. 1 to 4.

Although the coating 21 and/or the material forming the outer side 21 of the trim component are/is drawn in a planar manner in FIGS. 1 to 5, it can also be provided with embossment, or otherwise produced protrusions/depressions. This enables an optical effect that is desired by some aircraft operators. It also allows a better concealment of the covering 51, 52, in particular if it is inserted separately in the recess 41, 42 of the trim component 20, and has a peripheral joint. Thus such a joint can be concealed by the embossment.

FIG. 6 shows a strip-form detail of a plan view of the trim component 20 with a recess 41, 42. The viewing direction of the plan view in FIG. 6 corresponds to a view from below in each of the FIGS. 1 to 5 (from the interior), wherein the coating 21 and the covering 51, 52 are not represented in FIG. 6. Here the recess 41, 42 is formed in the shape of a single cell of a honeycomb structure (the remaining cells are shown hatched so as to simplify the figure). The trim component 20, 22 can, for example, be formed in terms of a honeycombed base body 20, 22 and a coating 21 applied onto the latter. One of these honeycomb cells is used as the recess 41, 42 in which the light source 31 is arranged. Alternatively, the cell 41, 42 shown in FIG. 6 can be formed by removing the appropriate base body material from a plurality of original cells.

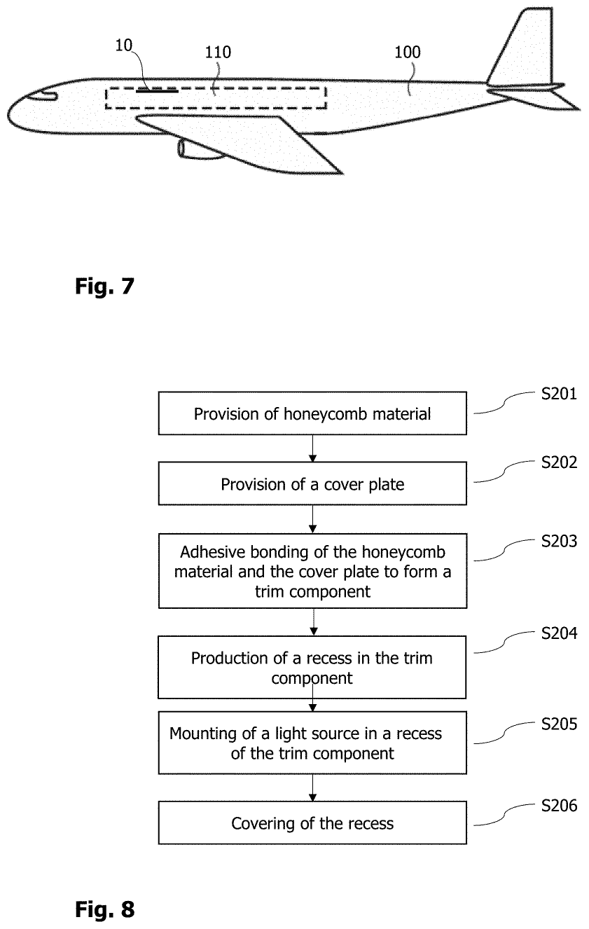

FIG. 7 shows schematically an aircraft 100, which has an interior 110. Here this could take the form of a passenger cabin 110, for example. Interior lighting 10 is arranged in the interior 110. For example, as shown in FIG. 7, the interior lighting 10 can form a ceiling panel for the interior 110. A plurality of recesses 41, 42 can be provided in this ceiling panel (the trim component 20, 22), so that a plurality of light sources 31 can be provided in the ceiling panel (the trim component 20, 22).

Finally, FIG. 8 shows a flowchart of a method for the production of interior lighting 10 for an aircraft 100. Firstly, in step S201, honeycomb material can be provided for a trim component 20, 22, and in step S202, a cover plate 21 can be provided for the trim component 20, 22.

In step S203, the honeycomb material is then adhesively bonded to the cover plate 21 to produce the trim component 20, 22. The honeycomb material and the cover plate 21 can, for example, each be made of plastic, and can be adhesively bonded together. Alternatively, the two materials can also be welded together.

In step S204 a recess 41, 42, is produced at least in the honeycomb material 20, 22. Since the recess 41, 42 can also be a cell in the honeycomb material 20, 22, step S204 can also take place before step S203. Irrespective of this sequence, in step S205 a light source 31 is mounted inside the recess. Here the light source 31 is arranged so that it emits light into an interior 110 of the aircraft 100 if the completed interior lighting 10 is installed in the aircraft 100. Here the light source 31 can be controlled so that it emits light only if the aircraft 100 departs from a normal operating mode and enters into a different operating mode.

Finally, in step S206, the recess 41, 42 is covered with a covering 51, 52, which has the optical characteristics of an outer coating 21 (of the cover plate 21) or a material of the trim component 20, 22, wherein the light source 31 is invisible from any position of the interior 110 of the aircraft 100 when viewing the trim component 20, 22 in the normal operating mode. Since the covering 51, 52 can be integrated in, or arranged on, the cover plate 21, step S206 can, needless to say, also be carried out together with step S202 or step S203.

The variants, designs and examples of embodiment discussed above serve only to describe the claimed teaching, but do not restrict the latter to the variants, designs and examples of embodiment.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An interior lighting for an aircraft comprising:
a light source, which is configured to emit light into an interior of the aircraft, when the aircraft departs from a normal operating mode;
a trim component with a recess, which is configured to accommodate the light source; and
a covering, which conceals the recess and has the optical characteristics of an outer coating, or a material of the trim component,
wherein the light source is invisible from any position in the interior of the aircraft when viewing the trim component in the normal operating mode.

2. The interior lighting according to claim 1, wherein the trim component is curved.

3. The interior lighting according to claim 1, wherein the recess is arranged on a side of the trim component facing the interior, and the covering on the side of the trim component facing the interior conceals the recess.

4. The interior lighting according to claim 1, wherein the covering forms a continuous surface with a surface of the trim component facing the interior.

5. The interior lighting according to claim 1, wherein the trim component is formed as a honeycomb structure.

6. The interior lighting according to claim 6, wherein the recess is formed in a single cell of the honeycomb structure.

7. The interior lighting according to claim 1, wherein the covering is embodied as an optical diffuser, which scatters the light of the light source emitted into the interior of the aircraft.

8. The interior lighting according to claim 1, wherein the covering has a semitransparent layer that is permeable to the light emitted by the light source in the direction of the interior of the aircraft.

9. The interior lighting according to claim 1, wherein the trim component further comprises a flexible printed circuit board to connect to the light source, arranged on a side of the trim component facing away from the interior.

10. The interior lighting according to claim 1, wherein the trim component, the recess, or both are further configured to accommodate completely a further light source for the normal operating mode, wherein the light source is equipped so as to emit light into the interior of the aircraft in the normal operating mode.

11. The interior lighting according to claim 1, wherein the trim component and the covering are formed in one piece.

12. A trim element for an aircraft, comprising:
a light source, which is configured to emit light into an interior of the aircraft, when the aircraft departs from a normal operating mode;
a recess, which is configured to accommodate the light source; and
a covering, which conceals the recess and has the optical characteristics of an outer coating, or a material of the trim,
wherein the light source is invisible from any position in the interior of the aircraft when viewing the trim in the normal operating mode.

13. An aircraft comprising:
the interior lighting according to claim 1, the trim element according to claim 12, or both.

14. A method for producing interior lighting for an aircraft, the method comprising:
providing honeycomb material for a trim component;
providing a cover plate for the trim component;
adhesively bonding the honeycomb material and the cover plate so as to produce the trim component;
producing a recess in at least the honeycomb material;
mounting a light source entirely within the recess, wherein the light source is configured to emit light when the aircraft departs from a normal operating mode; and
covering the recess with a covering, which has the optical characteristics of an outer coating or a material of the trim component, wherein the light source is invisible from any position in the interior of the aircraft when viewing the trim component in the normal operating mode.
